(19) United States
(12) Patent Application Publication
(10) Pub. No.: US 2017/0154708 A1
(43) Pub. Date: Jun. 1, 2017

(54) GEOPHYSICAL CABLE FOR SURVEYING HORIZONTAL AND RISING WELL SECTIONS

(71) Applicant: Zakryitoe Aktsionernoe Obschestvo "Geoptiks", Ekaterinburg (RU)

(72) Inventor: Evgeniy Vladimirovich Sharovarin, Ekaterinburg (RU)

(73) Assignee: Zakryitoe Aktsionernoe Obschestvo "Geoptiks", Ekaterinburg (RU)

(21) Appl. No.: 15/313,527

(22) PCT Filed: May 26, 2015
(86) PCT No.: PCT/RU2015/000328

§ 371 Date: Nov. 22, 2016

(30) Foreign Application Priority Data
May 26, 2014 (RU) 2014121140

(51) Int. Cl. H01B 7/04; H01B 7/18; G02B 6/44; H01B 7/00

(52) U.S. Cl. CPC H01B 7/046; H01B 7/0009; H01B 7/18; G02B 6/4416; G02B 6/443

(57) ABSTRACT

This invention relates to cable equipment, specifically, to geophysical cables, and is intended for lowering and lifting of geophysical instruments and devices, for supplying them with electric power, and for providing communication between surface equipment and instruments used during geophysical studies of horizontal and uphill portions of oil and gas wells. The geophysical cable for study of horizontal and uphill portions of wells contains at least one current-conducting core and an outside coating; at least one current-conducting core is located in a mass of polymer composite material armoured with glass or carbon fibers. The technical result of the proposed invention is to increase the longitudinal elasticity of a geophysical cable for study of horizontal and uphill portions of wells, which would ensure its self-rectification during operation, while preserving its strength and stiffness for pushing geophysical devices in horizontal portions of wells.

### CROSS-REFERENCE TO RELATED APPLICATIONS

This application is a U.S. National Phase of International Application No. PCT/RU2015000328, filed on May 26, 2015, which claims priority to and the benefit of Russian Patent Application No. 2014121140, filed on May 26, 2014, the entire contents of which are incorporated herein by reference.

### FIELD OF THE INVENTION

This invention relates to cable equipment, specifically to geophysical cables, and is intended for lowering and lifting of geophysical instruments and devices, for supplying them with electric power, and for providing communication between surface equipment and instruments used during geophysical studies of horizontal and uphill portions of oil and gas wells.

### BACKGROUND OF THE INVENTION

From the existing technology level, a geophysical cable is known which is intended for study of inclined and horizontal wells and includes current-conducting cores, electrical insulation, and double-lay armour; over the armour, a coating is applied, made of plastic material, 1.5 to 2.5 mm thick, an additional double-lay armour with gaps between individual wires in the outside lay, over which an overall coating is placed, which fills the gaps between the wires. (RF Patent No. 2087929, G01V3/18, published on Aug. 20, 1997.)

The design of the above-mentioned cable has gaps between the wires of the outside lay of the additional armour, which are filled with the polymer material of the outside coating, but the filling of the gaps between the wires of only the top layer of the outside armour pair does not ensure proper adhesion of the outside coating to the surface of the wires, and, consequently, does not guarantee a long service life of the cable in industrial environments.

A geophysical cable is known which contains one or multiple insulated current-conducting cords twisted into a core and placed inside an intermediary coating, over which an armour and an outside coating are applied. The armour consists of three or more lays. On the part of the cable designed for operation in inclined and horizontal portions of the well, beginning from the second or third lay of the armour, up to 75% of wires are cut off with uniform shift of the cut-off points over the part length at the transition from the bottom lay to the top lay, while the remaining wires constitute an armouring frame for polymer coatings, ensuring the reduction of the cable's specific density in that part by at least 20% in relation to the cable's specific density in the part designed for operation in the vertical portion of the well; the gaps between the wires are filled with polymer material during the application of the outside polymer coating. (RF Patent No. 2209450, G01V1/52, 3/18, H01B7/18, published on Jul. 27, 2003.)

This design of the cable ensures its flexibility; in this case, the placement of wire with 25% density fillage of the layer results in a significant reduction of the cable strength, and if the cable is used in horizontal portions of the well, it results in reduction of its axial stiffness.

The closest equivalent is a geophysical cable for study of inclined and horizontal wells, which is divided by its design into three parts; in the upper and medium parts, the core is made by twisting of insulated current-conducting strings and steel insulated wires around a central steel insulated wire, while in the lower part, which is designed for operation in inclined and horizontal portions of the well, the core is made by twisting of insulated current-conducting strings and fiberglass members around a central fiberglass member. An intermediary coating made of polymer material is applied on the core. On the intermediary coating in the upper part of the cable, two lays of steel zinc-coated wire armour are applied; in the middle part, the lay is applied with reduction of the number of wires; in the lower part, some wires are replaced with a fiberglass member close in diameter to the wires of the second lay of armour. Over the armour, an outside polymer material coating is applied. (RF Patent No. 69650, G01V1/52, published on Dec. 27, 2007.)

The design of said cable has a constant diameter over its length, which ensures high passage of horizontal portions of wells; in this case, in the lower part of the cable, designed for operation in horizontal portions of wells, elasticity is achieved by combining steel wires and fiberglass members, which do not ensure required stiffness and strength of the cable.

### SUMMARY OF THE INVENTION

The task that this invention aims to solve is to develop a design of a geophysical cable for study of horizontal and uphill portions of wells which would be free of the deficiencies of the above-mentioned equivalents, as well as to expand the selection of tools for the above-mentioned purpose.

The technical result of the proposed invention is to increase the longitudinal elasticity of a geophysical cable for study of horizontal and uphill portions of wells, which would ensure its self-rectification during operation, while preserving its strength and stiffness for pushing geophysical devices in horizontal portions of wells.

The proposed technical result is achieved by the fact that the geophysical cable for study of horizontal and uphill portions of wells contains at least one current-conducting core and an outside coating, where at least one current-conducting core is located in a mass of polymer composite material armoured with glass or carbon fibers.

It is appropriate that a steel wire would be placed in the mass of polymer composite material parallel to at least one current-conducting core.

It is appropriate that the outside coating would be made of polymer material.

It is appropriate that the outside coating would be made of gelcoat.

Optic fiber can be placed in the mass of polymer composite material parallel to at least one current-conducting core.

Unlike the prototype, a whole composite rod with a steel wire inside is used in the cable design to ensure necessary mechanical properties, rather than a combination of composite members and wires. Use of composite material in the cable design ensures superior strength, stiffness, wear-resistance and light weight of the cable. An outside coating made of gelcoat protects the material against premature wear. Gelcoat is resistant to chemical exposure, scratches, shocks and high temperatures. It is not prone to cracking and destruction at sharp temperature changes.

### BRIEF DESCRIPTION OF THE DRAWINGS

The invention is explained by the following illustrations.

FIG. 1 shows the design of a geophysical cable for study of horizontal and uphill portions of wells, where:

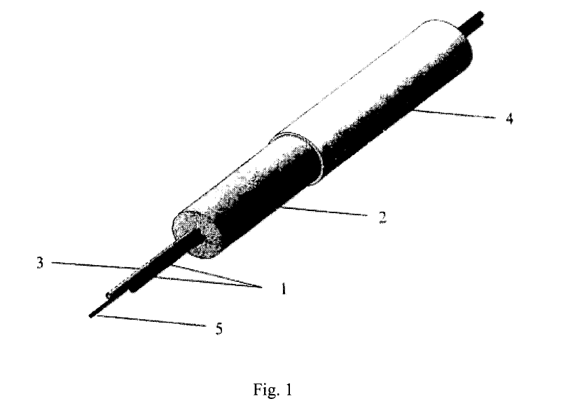

1—current-conducting cores;

2—polymer composite material;

3—steel wire;

4—outside coating;

5—optical fiber.

FIG. 2 shows a process diagram of study of a well using the proposed geophysical cable, where:

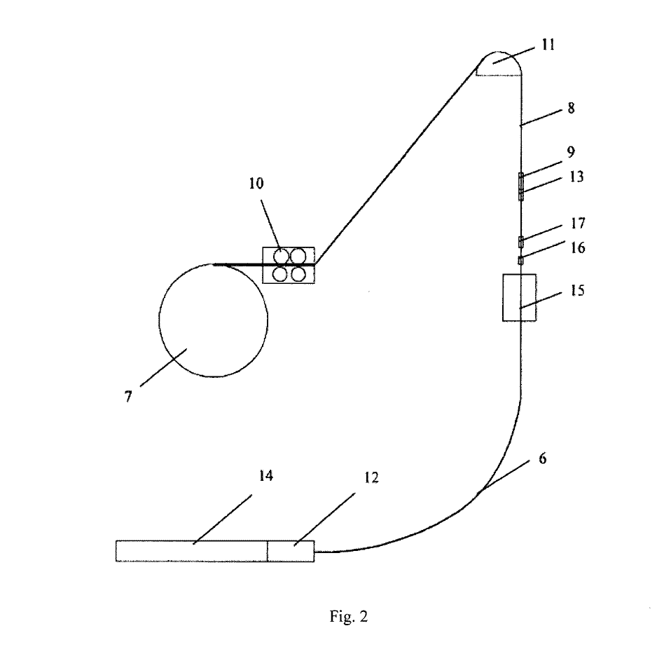

6—proposed geophysical cable for study of horizontal and uphill portions of wells;

7—drum with stiff geophysical cable of KGJ type;

8—stiff metal geophysical cable of KGJ type;

9—cable end of stiff geophysical cable;

10—geophysical lift;

11—roller assembly;

12—cable end of the proposed geophysical cable;

13—cable head of the proposed geophysical cable;

14—geophysical device;

15—wellhead equipment;

16—stop;

17—shutter.

### DETAILED DESCRIPTION OF THE INVENTION

The geophysical cable for study of horizontal and uphill portions of wells includes one or multiple current-conducting cores 1, located in a mass of polymer composite material 2, armoured with glass or carbon fibers. Parallel to at least one current-conducting core 1, a steel wire 3 for emergency retrieval of a geophysical device from the well and an optical fiber 5 for data transfer are located in the mass of polymer composite material 2. Over the polymer composite material 2, an outside coating 4 is applied for protection against premature wear; it is made of gelcoat or other polymer material. The nominal diameter of the cable can be from 8 to 30 mm, depending on the well's curvature radius and on the length of the well's horizontal portion.

The use of the proposed cable for study of horizontal and uphill portions of wells simplifies the study process and consists in the following.

25 to 30 metres away from the wellhead, a geophysical lift 10 is installed, with a stiff metal geophysical cable 8 of GKJ type wound onto a drum 7. The cable has a cable end 9 on the outside end of the cable 8.

25 to 30 metres away from the well, a drum is installed with the proposed geophysical cable 6 for study of horizontal portions of wells wound on it. The cable 6 has a cable end 12 on the outside (in relation to the drum) end, while on the inside end, it has a cable head 13, attached to the drum. A geophysical device 14 is fastened to the cable end 12. The cable 6 is passed through the roller assembly 11; then, the roller assembly 11 is suspended on the lift.

The device 14 on the cable 6 is lowered into the well, being passed into the wellhead equipment 15 through the stop 16 and shutter 17 installed on the wellhead equipment 15. The device 14 is lowered into the well to the whole length of the cable 6, and the cable 6 is fixed using the stop 16.

The cable head 13 of the proposed cable 6 is disconnected from the drum and connected to the cable end 9 of the geophysical cable 8. The cable 8 is slightly tensioned.

The stop 16 on the wellhead equipment 15 is released, and the cable 6 begins to be lowered using the geophysical lift 10.

Once the device 14 is lowered to the beginning of the horizontal portion of the well bore (“the heel”), the cable 6 continues to be lowered to the end of the horizontal portion of the well (“the toe”); in this case, the mass of the geophysical cable 8 located in the vertical portion of the well serves as the driver for pushing the proposed cable 6 to the “toe” of the well. The geophysical parameters of the well are recorded in various modes of the well's operation, moving the device 14 from the “toe” to the “heel” and back. The device 14 is lifted by winding the geophysical cable 8 on the drum 7.

Once the connected cable end 9 and the cable head 13 of the proposed cable 6 exit the well, the connection is pulled up to the drum of the geophysical lift 10, and the stop 16 is fixed on the well head. The cable end 9 and the cable head 13 of the proposed self-rectifying cable 6 are unbolted. The cable head 13 is fastened on the drum. The stop 16 on the well head is released, and the shutter 17 is closed in order to clean well fluid off the cable 6. Using an injector, the proposed cable 6 is pulled to the drum and simultaneously wound on the drum.

Once the geophysical device 14 exits the well, it is unbolted from the cable end 12 of the proposed self-rectifying cable 6, and the rest of the cable 6 is wound on the drum.

The design of the proposed geophysical cable allows to push geophysical devices into elongated horizontal portions of wells without using special downhole mechanisms.

Therefore, the proposed invention design will find a widespread application in geophysical studies of horizontal and uphill portions of wells.

What is claimed is:

1. A geophysical cable for study of horizontal and uphill portions of wells, comprising at least one current-conducting core and an outside coating, wherein at least one current-conducting core is located in the mass of polymer composite material armoured with glass or carbon fibers.

2. A geophysical cable as per claim 1, wherein, in parallel to at least one current-conducting core, a steel wire is located in the mass of polymer composite material.

3. A geophysical cable as per claim 1, wherein, in parallel to at least one current-conducting core, optic fiber is located in the mass of polymer composite material.

4. A geophysical cable as per claim 1, wherein the outside coating is made of polymer material.

5. A geophysical cable as per claim 4,wherein the outside coating is made of gelcoat.
